(19) United States
(12) Patent Application Publication
(10) Pub. No.: US 2018/0129211 A1
(43) Pub. Date: May 10, 2018

(54) NEXT GENERATION AUTONOMOUS STRUCTURAL HEALTH MONITORING AND MANAGEMENT USING UNMANNED AIRCRAFT SYSTEMS

(71) Applicant: InfraDrone LLC, Des Moines, IA (US)

(72) Inventors: Akash Vidyadharan, West Des Moines, IA (US); Tyler Carter, West Des Moines, IA (US)

(21) Appl. No.: 15/805,203

(22) Filed: Nov. 7, 2017

Related U.S. Application Data
(60) Provisional application No. 62/419,671, filed on Nov. 9, 2016.

(51) Int. Cl. G05D 1/00; G01M 5/00; B64C 39/02

(52) U.S. Cl. CPC G05D 1/0094; G01M 5/0033; B64C 2201/146; B64C 39/024; B64C 2201/123; G01M 5/0058

(57) ABSTRACT

A structural health monitoring and management system and oil and gas monitoring system includes a ground station having a computer, a cloud storage and a plurality of unmanned aircraft systems (UAS). Mounted to the UAS is a robotic arm and an ultrasonic system. The system includes multiple tiers for completing different diagnostic analysis.

### CROSS REFERENCE TO RELATED APPLICATION

This application claims the benefit to Provisional Application U.S. Ser. No. 62/419,671 filed on Nov. 9, 2016.

### BACKGROUND OF THE INVENTION

This invention is directed to an Unmanned Aircraft Systems (UAS). UAS offer unparalleled and unprecedented opportunities for performing cost-effective and efficient health monitoring and management of transportation infrastructure systems and turbines, oil and gas systems. Current infrastructure inspection methods are, in general, time-consuming, and costly to perform.

Testing civil infrastructure manually is an expensive and relatively dangerous task. Many times a lift or a crane is used to allow manual access to inspect the ‘hard to reach’ locations where damage may have occurred. Sometimes, places where inspection is desirable are deemed ‘impossible to reach’. The US currently has an aging infrastructure that is slowly crumbling and was given a G.P.A. of D+. Studies show that bridges in the US have a design life of 50 years but on average only last 42, causing an 8 year deficit in real world functionality versus design life. It was also found that 32% of roads in the US are in poor or mediocre condition, with a large percent of blame due to lack of inspection and maintenance. An imperative reason for this occurrence is that testing infrastructure on a regular basis can be an expensive endeavor. It was reported by Dubin and Yanev that the biannual visual inspection of the Brooklyn Bridge in New York cost around 1 Million Dollars.

Structural health monitoring (SHM) is an important tool to help improve the safety and maintainability of vital civil and transportation infrastructures. Due to the deterioration of civil infrastructure caused by time and other factors, the importance of SHM cannot be underemphasized. As of today, SHM is performed manually by engineers, technicians and inspectors spending vast amounts of field time mapping and inspecting the structure defects with the help of tripod or vehicle mounted equipment which have limited reach. Advances in bridge SHM have been enhanced with the help of stationary sensors that are strategically placed under or on the surface of the structure, capable of monitoring stresses and vibrational loads. Unfortunately, infrastructures that are old or located in remote areas cannot be monitored using such embedded sensor techniques. Current inspection practices involve visual inspections, acoustic emission, ultrasonic testing, etc. These techniques revolve around previous knowledge of where the damage is, in order to perform a detailed study of the holistic condition of the structure.

To address these problems introduced is a multi-tiered network of UAS which can be utilized to perform an array of tasks such as surveillance, 3-D rendering using photogrammetry, High Definition (HD) visual monitoring, Light Detection & Ranging (LiDAR) tests, infrared thermography, multispectral modelling, and Non Destructive Evaluation (NDE) using Ultrasonic Testing (UT). These methods can be used for monitoring both the microscale and macroscale defects of infrastructures resulting in detailed inventory, survey, and condition assessment of transportation infrastructure systems. The purpose of each tier of the proposed system as well as how the UAS data from each tier may be further processed to accurately assess the condition of the structure being monitored are discussed. The modular and multi-purpose nature of UAS is emphasized where UAS can be equipped with a variety of application-specific payloads such as LiDAR, infrared thermal imaging camera, and ultrasonic transducers resulting in a range of civil and transportation application. Also provided is a vision for next-generation, autonomous health monitoring of transportation infrastructure systems using UAS.

In part, the invention takes advantage of the new rules put forth by FAA regarding the operation of small UAS (Federal Aviation Administration 2016) and use a swarm of UAS to monitor different types of structures autonomously in order to provide a holistic view of the condition of the structure being surveyed. The use of UAS will open up new domains of unexplored potential in the field of SHM and provide an efficient solution to the current techniques being employed. In order to implement this system in an efficient manner, we will use the Value Driven Design (VDD) approach of Systems Engineering. The methodology will provide an interdisciplinary approach to the implementation of the system while being able to communicate the design requirements with the preferences of the stakeholders. This will help in identifying relationships between the subsystems of the overall system while including economic theories to better optimize the design and operation of the UAS swarm based on the mission scenario while incorporating the preferences of the stakeholders.

### SUMMARY OF THE INVENTION

A Structural health monitoring and management system includes a ground station having a plurality of computers and monitors having a processor and a plurality of software. The computers are wirelessly connected to a cloud storage and a plurality of UAS. The system performs multiple operations where the UAS collect and transit data to the cloud storage and/or the computer for review and analysis. The computer controls the operation of the UAS and the cloud storage.

The multiple operations or tiers include rendering and virtual reconstruction, high definition and visual inspection, light detection and ranging, infrared thermography, and/or ultrasound nondestructive evaluation. Another operation involves an NDT system having a robotic arm, an ultrasonic system, and other components mounted to one or more UAS. A control system wirelessly operates the robotic arm ad UAS so that data of a structure is transmitted to cloud storage and/or the control system for analysis.

### BRIEF DESCRIPTION OF THE DRAWINGS

FIG. 1 is a schematic view of the environment of a structural health system;

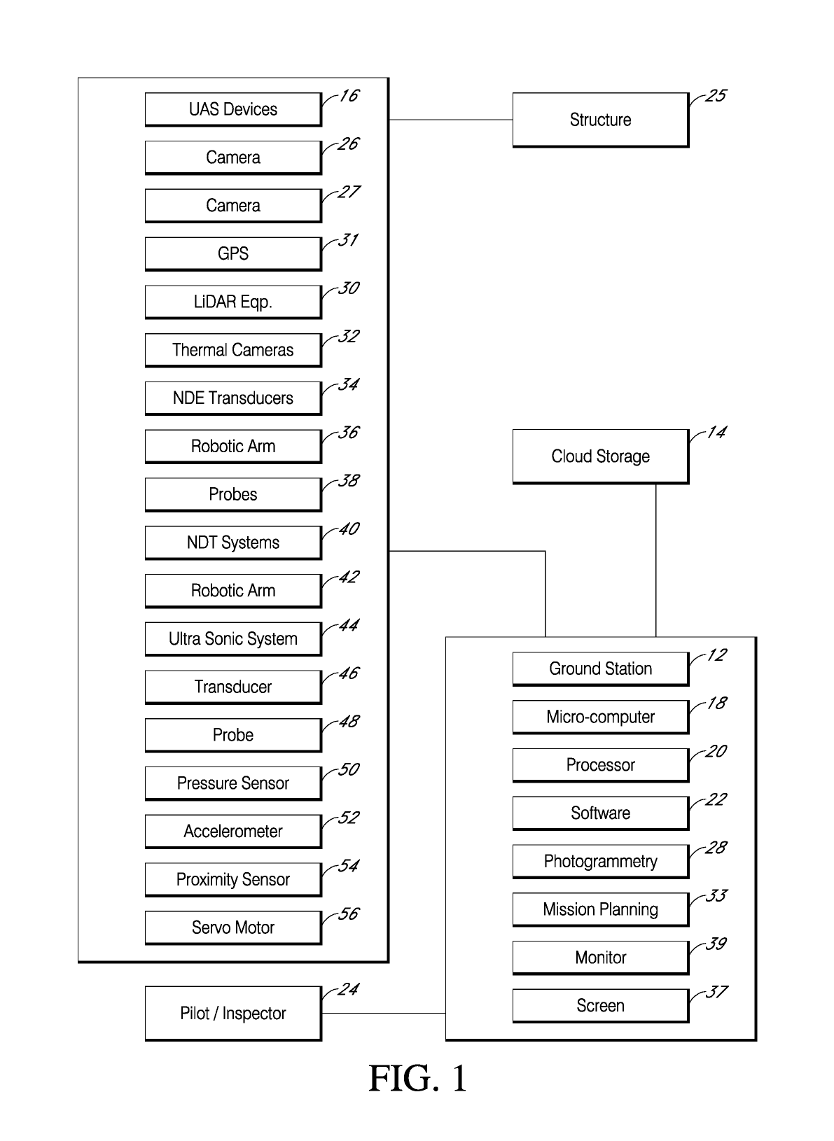

FIG. 2 is a schematic view of different operations of a structural health system; and

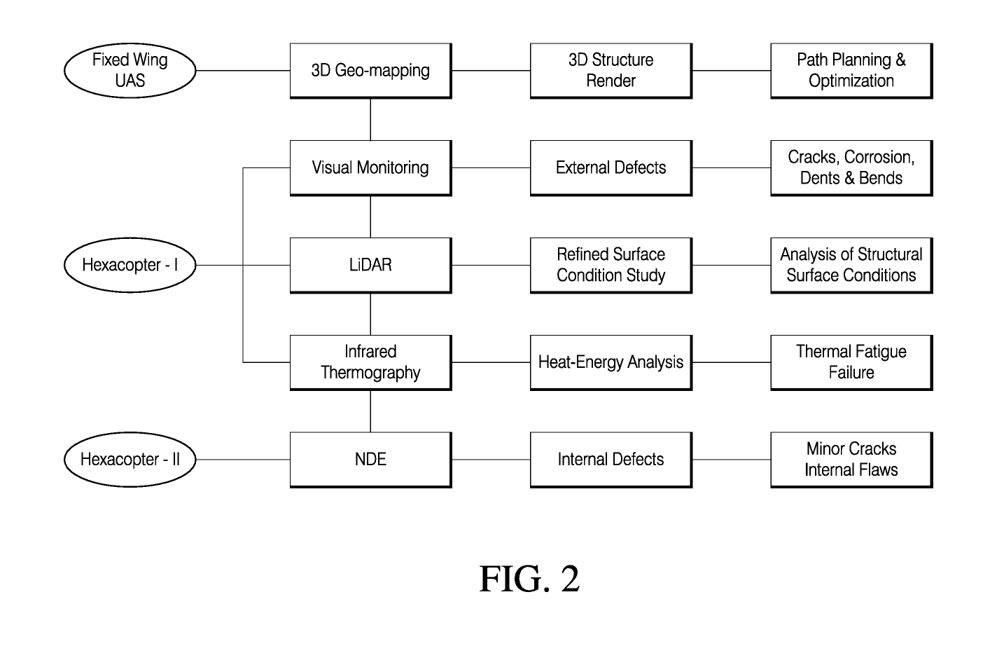

FIG. 3 is a perspective view of an unmanned aircraft system (UAS).

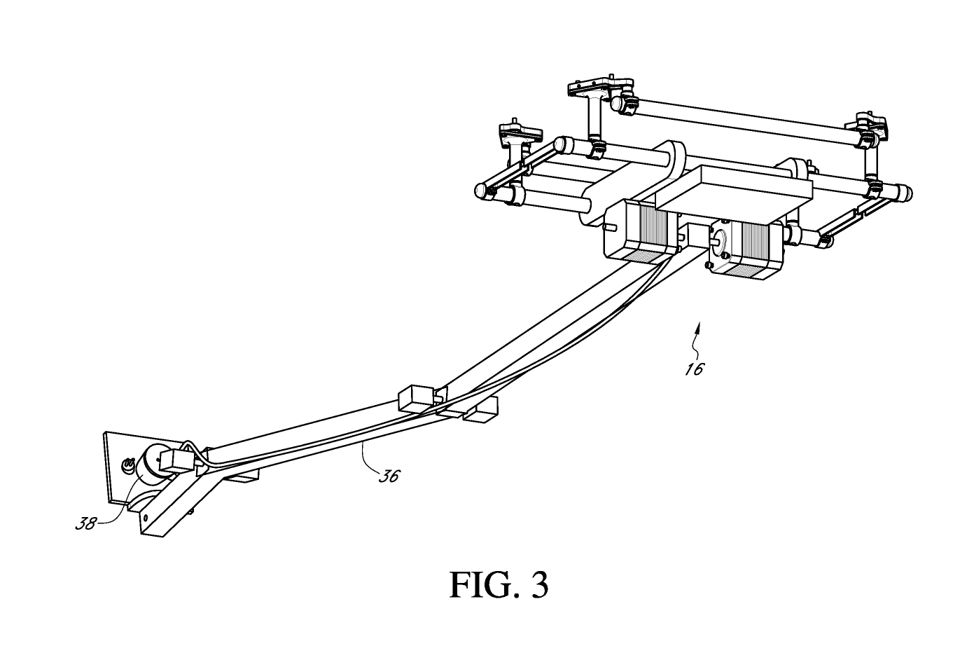

### DETAILED DESCRIPTION OF THE PREFERRED EMBODIMENTS

Referring to the Figures, the autonomous structural health monitoring and management system 10 includes a ground station 12, a cloud storage 14, and a plurality of UAS devices 16. The ground station 12 includes a micro-computer 18 having a processor 20 and a plurality of software application 22. The micro-computer 18 is operated by an individual such as a pilot and or inspector 24. Both the cloud storage 14 and the UAS devices 16 are wirelessly connected to the micro-computer 18.

The implantation of the next generation autonomous SHM systems 10 will use a network of UAS to perform an array of tasks such as surveillance, 3-D mapping, HD visual inspection, infrared thermography, LiDAR scans and Ultrasound NDE. A large scale multi-tiered system is utilized of autonomous SHM for transportation and civil infrastructure using UAS. Each tier of UAS will carry its own payload and has its own purpose and objectives, such that the results obtained from a previous tier may be used as a starting point to support the operations of the next tier.

The UAS used in different tiers of this system have been custom designed and purpose built in a modular style, which allows it to be used as a multipurpose platform capable of carrying a wide variety of payloads that may be switched depending on the task at hand. Heavier equipment used to perform NDE and infrared thermal imagery will require a more capable heavy lift UAS. The physical attributes of the different types of UAS designs and the size of structures being scanned is used as a deciding factor to assign roles to each type of UAS. For example, the 3-D mapping of a large structure 25 would require a fixed Blended Wing Body UAS due to its high endurance, while a close up visual inspection and NDE of a structure would require a Hexacopter UAS due to its attributes such as high stability and precise control. State-of-the-art guidance and control systems are used to validate precision controls and enable autonomous flight capabilities for a UAS to minimize the role of a human operator in the loop.

### Tier 1: 3-D Rendering and Virtual Reconstruction

The first tier of our system involves using either a fixed wing UAS 16 or a lightweight quadcopter (depending on the size of the structure) to perform aerial surveillance and monitoring with the help of a live stream HD camera 26 mounted on the UAS 16. The flight modes are controlled manually by a pilot or performed semi-autonomously by a 2-D flight mission planner.

Another important aspect of this tier involves using photogrammetry software 28 to render 3-D reconstructions of the infrastructure being monitored. This step will be performed by flying one or more UAS 16 around the structure 25 to strategically capture images with geotagging support. After that, the captured images are aligned using tie points in order to create a point cloud, which may be meshed and textured to provide an accurate rendering of the structure.

Once the dense point cloud has been generated, a mesh is generated using the cloud points and may be interpolated and extrapolated to provide a solid 3-D rendering of the structure. After the solid mesh generates, a texture may be applied on the mesh model, which relies on information from the original images. The model can also be manually or automatically dimensioned and geographically positioned up to a tested accuracy of less than 5%. The 3-D renders and aerial imagery will provide support for tier 2 operations when close-up HD visual inspections using virtual reality (VR) systems and scaled 3-D printing of the structures. Using the 3-D renderings generated, it is possible to perform a virtual walkthrough and inspection of the structure in high definition, which enables a very immersive view of the model from an entirely new perspective.

### Tier 2: High Definition Visual Inspection

The HD visual inspection is carried out using the UAS 16 with a HD camera 29 mounted on a 2 axis rotatable gimbal, which allows the inspector 24 to change the direction of the camera 29 and focus to get better pictures of the defects on the structure 25. HD images of cracks and corrosion on a pavement and other structures are detected.

This operation is supported by an open source 3-D autonomous waypoint mission planning and simulation software 33 that can import 3-D renderings of the structures 25 acquired from tier 1. This way, the user may take pictures remotely with the help if live transmission from the UAS camera 24 without colliding into the structure 25 during autonomous flights.

The tier will help to expose the visible defects on the infrastructure such as cracks, corrosions, dents, and bends. Further image processing and analysis of the defects is performed using a combination of proprietary software techniques.

### Tier 3: Light Detection and Ranging

Tier 3 of the system 10 involves using LiDAR equipment 30 attached to a UAS 16 in order to generate extremely high quality 3D contour and digital elevation models). LiDAR uses a variety of systems including GPS 31, inertial navigation, high speed computing, and laser-range finders and works in a similar manner as RADAR when it comes to data collection. The LiDAR transmits light towards a target or series of targets and a receiver in the LiDAR records the reflected light. They can be extremely accurate in recording hundreds of thousands of points per second in order to generate a highly accurate dense point cloud. The time taken for the light to be received by the LiDAR is used to calculate the distance to the target and is taken into consideration during the modeling process (Harrap). Once the LiDAR collects the data and the model is generated, it may be used to create Digital Elevation Model (DEM) and Building Information Models (BIM) (Shamayleh 2003).

Using LiDAR, it is possible to measure surface defects up to millimeters of accuracy, which is extremely useful for structural health monitoring purposes. LiDAR is used to focus on the detection and analysis of miniscule defects in civil and transportation infrastructure including, but not limited to roads, railroads, bridges, and buildings. When focusing on highways, LiDAR has a list of potential uses such as detecting cracks, ruts, 3D pothole geometry, sight distance models, side slope models, grade models, and contour models (Olsen 2011). High quality and accurate LiDAR models can help locate critical areas of concern, which can then be inspected further by using thermography and ultrasound NDE from Tiers 4 and 5.

After Tiers 1 and 2 are completed, the LiDAR flight path plan may be created by the software 33 based on the visible defects located on the structure 25. Using the UAS 16, the LiDAR scan assists in extremely high accuracy detection of cracks and surface condition modeling for a variety of other defects as well. For this reason, the utilization of LiDAR is crucial to the overall testing and inspection system. Using LiDAR it is possible to obtain Digital Elevation Models (DEM), including Digital Surface Models (DSM) and Digital Terrain Models (DTM) as shown in Figure. I 0. A DEM is a point cloud generated from the LiDAR, which is displayed on a computer 18 and has a high level of geometric accuracy and can be used to measure the distance between points A DSM is a subset of the DEM in which only the strongest return of an individual pulse is recorded and generated in the dense point cloud. A DTM is a subset of the DEM in which only the last return of an individual pulse is recorded and generated in the dense point cloud.

### Tier 4: Infrared Thermography

Infrared thermography is a visual method of non-destructive evaluation that can be very useful for a variety of purposes. Thermal cameras 32 detect infrared radiation in wavelengths as long as 14,000 nm and display the radiation using colors in the visual spectrum (Monroe Infrared 2014). There are currently two types of IR thermography which fall under passive and active categories. The passive approach is more useful for a UAS 16 approach due to one of the requirements of the active approach being an external heat source (Avdelidis, N. P. et al. 2004). The applications of passive infrared thermography are extensive and can be used for thermal diagnostic applications such as power line inspection, roof insulation inspection, photovoltaic solar panel inspection, irrigation inspection, energy loss inspection, plant yield estimation, search and rescue, corrosion detection etcetera (Prebhu, D. R., and W. P. Winfree 1993). The main advantages of using passive infrared thermography are the ability to have a quick inspection without physical contact to the point of interest and the ease of interpretation of the images. The main disadvantages of using passive infrared thermography are the emissivity problems as well as the convective and radiative heat losses which interfere with the results (Maldague 2002).

Infrared thermography cameras 32 that work with UAS 16 must be lightweight and relatively small enough to fit beneath the UAS 16. The thermal camera 32 has a variety of other features that may be useful such as max/min temp detection, emissivity correction, Lightbridge compatibility, and a temperature alarm mode.

### Tier 5: Ultrasound Nondestructive Evaluation

Once a digital surface condition map along with the surface condition model of the structure has been obtained from the LiDAR & thermal imaging tests, major areas of concerns or ‘hotspots’ can be set aside as crucial areas of interest for the UAS 16 to perform NDE on. The NDE tier may be performed not just by Ultrasound testing, but also by other non-contact methods such as high power ground penetrating radar or other acoustic methods. Ultrasound NDE relies on high frequency sound energy being transmitted through a material using pulser-receiver piezoelectric transducers 34 to detect inconsistencies and defects both on and underneath the surface being tested. The high frequency sound energy propagates through the material and whenever there is a defect such as a crack in the wave path, energy will be reflected back from the flaw surface and is converted into electrical signals to be displayed on a screen 37 (NDT Resource Center 2014). The UT module mounted on the UAS 16 will have the capability to provide at least A-scan results, which is the plot of Ultrasound energy vs Time function. Using the A-scan results, one is able to obtain the location and intensity of the surface and subsurface defects on the infrastructure to be tested. In order to implement a robust and flexible system for performing NDE, the ultrasonic transducers 34 will be held by a remotely controlled robotic arm 36 mounted on the UAS 16. Since the ultrasonic transducers 34 require a layer of couplant to transmit the ultrasound energy through the region of the structure 25 being tested, roller transducer probes 38 which have a layer of hydrophilic solid couplants embedded in them are used for simplifying this complex procedure (Bourne). This will provide the user the ability to control the movement of the transducers 34 from the ground when the UAS 16 performs autonomous maneuvers around the hotspot regions of the structure 25. Since the equipment required to perform NDE are significantly heavier than the equipment from the previous tiers, a new UAS is used which has a higher endurance, payload, and precision to perform this task.

In practice, the links that form the robotic arm 42 are not perfectly rigid, and therefore, are considered as “structural flexibility”. Structural flexibility of the arm 42 leads to the appearance of oscillations at the tips of the link. The control problems of a flexible arm can be divided into four principal objectives: 1) End-effector position regulation, 2) Rest to rest end-effector motion in fixed time, 3) Tracking of a desired angular trajectory, and 4) Tracking of a desired end-effector trajectory. To address these challenges an adaptive control technique is used. The control scheme uses an LQR regulator, computed on linearization of the robot nonlinear Lagrangian dynamics. A Strong Tracking Filter which is fed in with the control torque and the end-effector position will be used to regulate joint coordinates, elastic coordinates, and error dynamics vector states feedback, including parametric model and unstructured uncertainties.

For the most accurate results with maximum S/N ratio, an ultrasonic transducer 46 is required to be positioned in a constant distance from the surface. Additionally, in order to “catch” the initial signal, the sensor needs to be positioned perpendicular to the surface. A pressure sensor 50 and an accelerometer 52 are also positioned at the end of the arm. The accelerometer 52 is used to normalize the position of the sensor 50. However, to obtain more accurate results, and increase the ability of the device to inspect the structure at any orientation, it is replaced by two tilted ultrasonic proximity sensors. The proximity sensors are connected to a servomotor 50 to accurately adjust the ultrasonic transducer 40 to be positioned perpendicular and in the focal distance with respect to the test surface. The data from the proximity sensors 54 will be processed by a microcontroller 18. The interfacing pins connect to three different servo motors 56 located at each end of the arms 42, the medium link, and proximity sensors 54. The robotic arm 42 links are required to have maximum stiffness while being light for the minimum payload. Therefore, arm links preferably will be manufactured from unidirectional Carbon Reinforced Polymers (CFRP).

In another embodiment, an NDT system 40 is used that is highly portable and has a powerful ultrasonic system. The NDT system is attached to a UAV system to effectively detect structural defects, cracks and corrosion without the need for expensive, unsafe, and slow access methods that are currently used for ultrasonic inspection.

The system can include an advanced robotic arm 42 attached to a UAV 16 to maintain a constant distance and a perpendicular angle to the surface of an inspecting structure 25, a miniaturized ultrasonic system 44, and finally an ultra-portable light ultrasonic transducer 46 that include ultrasonic roller-probe transducers and waterjet transducers that seamlessly scan hard to reach surfaces.

The robotic arm 42 keeps the ultrasonic probe 48 within the focal length of an ultrasonic transducer 46 to the structure 25. The arm 42 is controlled by micro-computer 18 utilizing software 22. In one example, the software 22 maintains constant pressure on a plane surface. The software 22 also controls the arm adjustment based on flight path variations. Other components attached to the UAS 16 include a D-RTK, a video transmitter, a water pump and other transmitter-receiver systems. Each of these on board systems are accessed and remotely controlled to start and stop data collection by the microcomputer 18.

The ground station 12 setup will consist of monitors 39 that will actively track the telemetry of the UAS 16, status of the ultrasonic data being recorded through a live feed and a live FPV video feed from the UAS. This ground station 12 will be controlled by a Windows based computer 18 connected to two 2.4 GHz and two 5.8 GHz antennas operating simultaneously. This setup will be made to be portable and lightweight so that it may be set up and operated with ease by no more than two operators. This ground station 12 is designed to control and monitor all the aerial systems conveniently from the ground.

Developing an effective control apparatus that can dampen the natural movement of the UAV due to wind gusts is critical to success. Even though the ultrasonic signal will be received by the sensor in a millisecond time frame, the robotic arm needs to dampen the vibrations, as well as ensuring that the sensors do not crash into the structure.

This problem is tackled through a hierarchical control architecture. In the top layer, an inverse kinematics algorithm calculates the motion references for the actuated variables, i.e., position and yaw angle of the UAS and joint variables for the manipulator, while in the bottom layer, a motion control algorithm is in charge of tracking the motion references. Since the quadrotor is an under-actuated system, the position and the yaw angle are usually the controlled variables, while pitch and roll angles are used as intermediate control inputs for position control. The time derivative of the differential kinematics is considered to derive a second order closed-loop inverse kinematics algorithm, in charge of computing the trajectory references for the motion control loops at the bottom layer. Once control variables and its components are calculated, they are fed to the motion control to achieve the desired motion. The controller is similar to Caccavale et al, where the outer loop is designed to track the UAS reference position; then, by using the relation between the force vector and the attitude, a reference value for the roll and pitch angles is devised and fed to the inner loop (attitude controller).

The wireless transmission control system will have the primary function of not only controlling the UAS, robotic arm and the ultrasonic system, but also transmitting and viewing the ultrasonic data collected by the UAS from the ground station. To achieve a robust and reliable two way communication system is in place with an accuracy of 1 cm to pinpoint the location of the defect on the structure. This system is able to transmit the data with very little to no lag and eliminate as much noise as possible in order to transmit clear and useful data to the ground that can be viewed and analyzed by the operator with minimal effort. A wireless radio communication system and a ground station, supported by multiple levels of fail-safes ensures quality data to be collected by the on-board sensors and transducers. Usually, such systems have used simple methods of wireless communication such as Bluetooth or Wi-Fi as a mode of transmitting data wirelessly across short distances. These methods of wireless data transmission are severely hindered by their short transmission range of less than 100 meters at its best and are plagued by disconnectivity and significant lag, which could be very detrimental to the quality of data collected and viewed by the UAS operators. Due to these shortcomings of other communication methods, a radio communication to not only control the functionalities of the UAS and other robotic components, but is used to transmit live video and ultrasonic data to the operator on the ground.

A major challenge of using RF communication is signal interference. It can result in connectivity loss, which may have adverse effects on our proposed use of RF communication for aerial NDT using UAS. One of the best solutions to combat connectivity loss in radio frequency communication is a protocol for certain radio frequency modules and transceivers called FHSS or Frequency Hopping Spread Spectrum. This technique utilizes a number of different frequencies through a select range of frequencies to communicate and transmit data. This technology allows unknown atmospheric, external, and man-made interference to have less of an effect on the signal connection between transmitter and receiver modules. Incorporating this technology to the RF transmission of the live ultrasonic data would add accuracy and effectiveness of the received data at the ground station.

The system to control the UAS and robotic arm includes four main radio communication channels: A 2.4 Ghz radio frequency communication to control movement of the UAS itself, a 2.4 Ghz radio communication to control the functions of the robotic arm and pump system, a 5.8 Ghz video transmitter that will transmit live video from the UAS, and finally a 5.8 Ghz digital transmitter which is used to relay the ultrasonic B-scan data to the ground station. To achieve this, a transmission hardware that uses 2.4 GHz communication that can be connected to the ground station, which would enable an automated flight control of the UAS, and a 5.8 GHz radio frequency communication to view the live ultrasonic B-scan data is used. To control the robotic arm and pump system, a separate 2.4 GHz radio controller is used. A lightweight 5.8 Ghz video transmitter and board camera providing live video with little to no lag directly from the arm provides the best visual cue to the relative position of the robotic arm to the operator. These capabilities allow the pilots at the ground station to see clearly the structure being scanned from the convenience of a few screens. The ground station will consist of three monitors, each serving its own purpose: (i)View telemetry and mission details of UAS and robotic arm system (ii) View the live readout of the ultrasonic B-scan data (iii) The live first person view (FPV) video from the UAS.

A well tested and useful redundancy and safety feature of the UAS is its capability to return to the takeoff point autonomously, through the integration of the GPS and IMU, at the command of the pilot with the push of a button. This smart functionality will also automatically bring the UAS back home at the fault of losing connection to the ground station from going out of range or from interference. The required precision will be achieved with the help of a RTK (Real time kinematics) system that provides the UAS with centimeter level accuracy in the horizontal and vertical axis, complemented by an active on-board dampening system, which would allow the robotic arm to operate sensitive sensors with precision while mounted on the UAS. Such features would help to provide the operators with the required levels of autonomy and redundancy to safely operate this system.

The wireless ultrasonic system is used to detect and record acoustic emission activity using ultrasonic probes such as roller probe transducers through contact-based measurement method, and non-contact immersion sensors such as waterjet squirters. Furthermore, a completely wireless sensor within a miniaturized and battery operated design is used that can independently record and analyze ultrasonic signals. An active inspection regime, requires continuous communication between the ultrasonic sensor and data acquisition in the air to post-processing and display on the ground station.

The capabilities of the applications used in the multi-tiered system used span across multiple industries and may be developed with the ability to fine tune any tier depending on the mission being performed. This proposed multi-tiered system will contribute a new era of civil & transportation infrastructure inspections and testing where information can be obtained and analyzed with ease relative to prior methods. UAS based SHM may also be integrated with existing manual and sensor based techniques to further the understanding of the condition of the structure. The proposed method will give inspectors an opportunity to work more efficiently with the help of next generation state-of-the-art equipment, thereby reducing the man hours required on site.

The use of UAS for SHM will have a positive impact on the civil, construction & transportation infrastructure since it allows inspection and testing to occur at a more significantly frequent pace than when performed manually, since manual health monitoring of infrastructure involves hiring personnel and heavy equipment to perform inspection which can be expensive, time consuming and risky. The system will significantly lower the cost, time, and risk involved in performing health monitoring of transportation infrastructure by using UAS to perform 3D rendering, high resolution crack & corrosion detection; road surface condition & pothole depth analysis using LiDAR and ultrasonic NDE to measure micro and sub-surface defects.

Additional applications include testing 3D rendering structures using photogrammetry and HD visual inspections with autonomous waypoint navigation as explained in Tiers 1 & 2. The system involves the use of image processing tools to analyze the HD images captured by the UAS in Tier 2 and obtain a fair estimate of the intensity of defects present on the structure. Also, using multiple UAS in coordination to simultaneously perform different tasks in different regions of larger structures to further mitigate field time required for inspection. In addition, by obtaining the mobile LiDAR and infrared thermal camera to explore and understand the application and limitations of incorporating remote sensing equipment into UAS to supplement the SHM process. The implementation of NDE requires designing and building a new type of UAS capable of holding the ultrasound transducer on a robotic arm.

What is claimed is:

1. An NDT (Non-Destructive Testing) system for detecting structural defects, delamination, dimensions, distances, cracks, and corrosion, comprising:
an unmanned aircraft vehicle (UAV);
an NDT sensor connected to the UAV; and
a control system connected to and controls the operation of the UAV and the NDT sensor.

2. The NDT system of claim 1 further comprising a robotic arm attached to the UAV and controlled and operated by the control system.

3. The system of claim 2 wherein the UAV and robotic arm are positioned by the control system so an ultrasonic probe is within a focal length of an ultrasonic transducer.

4. The system of claim 2 wherein the control system positions the UAV and the robotic arm at a constant distance and angle to a surface of a structure.

5. The system of claim 1 wherein the UAV is positioned using at least one selected from a group consisting of tap testing, eddy current and ultrasonic.

6. The system of claim 1 wherein the control system dampens vibrations of the UAV.

7. The system of claim 1 wherein the control system transmits and stores ultrasonic data, eddy current data and tap testing data collected from the UAV to a ground station for viewing.
